(19) United States
(12) Patent Application Publication
(10) Pub. No.: US 2026/0295754 A1
(43) Pub. Date: Oct. 1, 2026

(54) COVER MEMBER AND MACHINE TOOL

(71) Applicant: FANUC CORPORATION, Minamitsuru-gun, Yamanashi (JP)

(72) Inventors: Masumi YOSHIDA, Minamitsuru-gun, Yamanashi-ken (JP); Takuya KUNISHI, Minamitsuru-gun, Yamanashi-ken (JP); Takeshi SUMI, Minamitsuru-gun, Yamanashi-ken (JP); Hiroki TEZUKA, Minamitsuru-gun, Yamanashi-ken (JP)

(73) Assignee: FANUC CORPORATION, Minamitsuru-gun, Yamanashi (JP)

(21) Appl. No.: 19/480,193

(22) PCT Filed: May 8, 2023
(86) PCT No.: PCT/JP2023/017268

§ 371 Date: Oct. 30, 2025

(51) Int. Cl. B23Q 11/08

(52) U.S. Cl. CPC B23Q 11/0825

(57) ABSTRACT

A cover member according to the present disclosure protects a feed shaft mechanism that feeds a table of a machine tool while supporting the table from below. The cover member comprises: an outer wall part that covers the feed shaft mechanism; and an inner wall part that is positioned between the outer wall part and the feed shaft mechanism, that is spaced apart from the outer wall part, and covers the feed shaft mechanism. One of the outer wall part and the inner wall part includes an inclined section that extends obliquely downward toward a lower end section of the other of the outer wall part and the inner wall part, and that forms a gap between the lower end section and the inclined section itself.

### TECHNICAL FIELD

The present disclosure relates to a cover member and a machine tool.

### BACKGROUND ART

JP 2004-255545 A discloses a cover member (a movable cover) provided on a table (a worktable) of a machine tool.

### SUMMARY OF THE INVENTION

There is a need for a better cover member and machine tool.

A first aspect of the present disclosure is characterized by a cover member that protects a feed axis mechanism, the feed axis mechanism feeding a table of a machine tool while supporting the table from below, the cover member including an outer wall portion that covers the feed axis mechanism, an inner wall portion that is located between the outer wall portion and the feed axis mechanism, is separated from the outer wall portion, and covers the feed axis mechanism, wherein one of the outer wall portion or the inner wall portion includes an inclined portion extending obliquely downward toward a lower end portion of another of the outer wall portion or the inner wall portion, and forming a gap between the inclined portion and the lower end portion.

A second aspect of the present disclosure is characterized by a machine tool including the cover member, the table, and the feed axis mechanism.

### BRIEF DESCRIPTION OF DRAWINGS

FIG. 1 is a schematic diagram illustrating a machine tool according to an embodiment;

FIG. 2 is a schematic diagram illustrating a part of the machine tool;

FIG. 3 is a schematic diagram illustrating a part of the machine tool;

FIG. 4 is a schematic diagram illustrating a machine tool according to Modification 1; and

FIG. 5 is a schematic diagram illustrating a machine tool according to Modification 2.

### DETAILED DESCRIPTION OF THE INVENTION

JP 2004-255545 A proposes to guide foreign materials, such as chips and cutting fluid, under a table by using a cover member provided around the table. However, a feed axis mechanism, which is a mechanism for feeding the table in a predetermined feed axis direction, is provided under the table. When the foreign materials adhere to the feed axis mechanism, there is a possibility that the operation of the feed axis mechanism is hindered.

Based on the above preliminary description, an embodiment will be described below.

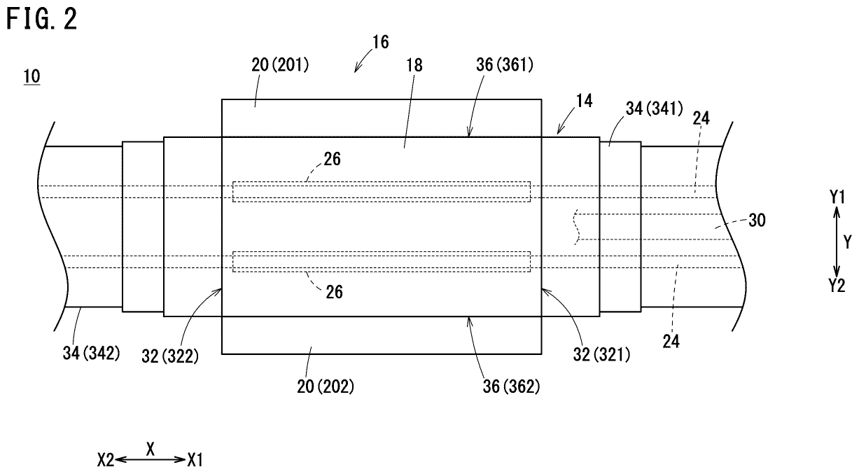

Note that each of an X direction and a Y direction used in the following description is a direction parallel to a horizontal plane (horizontal directions). The X direction and the Y direction are mutually perpendicular to each other (see also FIG. 2). The X direction includes an X1 direction and an X2 direction opposite to the X1 direction. The Y direction includes a Y1 direction and a Y2 direction opposite to the Y1 direction.

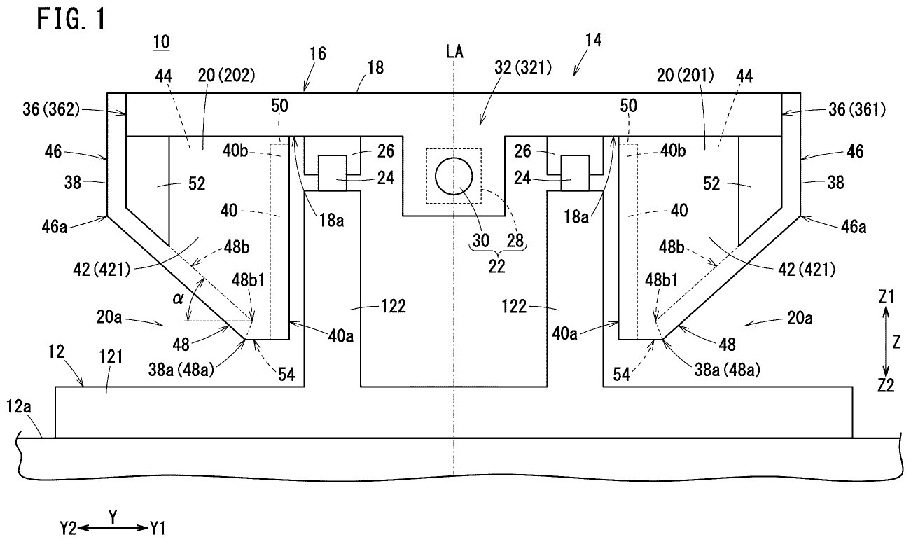

In addition, a Z direction used in the following description is a direction perpendicular to the horizontal plane. That is, the Z direction is the up-down direction (the vertical direction). The Z direction includes a Z1 direction that is an upward direction and a Z2 direction that is a downward direction (the direction of gravity) (see also FIG. 1).

### Embodiment

FIG. 1 is a schematic diagram illustrating a machine tool 10 according to an embodiment. FIG. 2 is a schematic diagram illustrating a part of the machine tool 10.

The machine tool 10 is a machining device such as a machining center. The machine tool 10 includes a support member 12, a feed axis mechanism 14, and a table unit 16. The table unit 16 includes a table 18 and a pair of cover members 20.

Although not shown, the machine tool 10 further includes a spindle head located above the table unit 16. A tool used for machining by the machine tool 10 is mounted on the spindle head. The spindle head (spindle) may have a discharge port for discharging cutting fluid (center-through type).

The support member 12 is, for example, a saddle of the machine tool 10. The support member 12, which is a saddle, can be supported by a base (bed) (not shown) provided in the machine tool 10. In FIG. 2, the support member 12 is not shown.

As shown in FIG. 1, the support member 12 includes a base portion 121 and a pair of rail support portions 122 protruding upward from the base portion 121. The pair of rail support portions 122 support a pair of guide rails 24 described later.

As shown in FIG. 1, the support member 12 may have a slide portion 12a. The slide portion 12a is supported by, for example, a guide member (a guide rail) (not shown) so as to be slidable in the Y direction.

The feed axis mechanism 14 is a mechanism for moving the table unit 16 in a feed axis direction. In the present embodiment, the X direction coincides with the feed axis direction. The feed axis mechanism 14 includes a ball screw 22, the pair of guide rails 24, and a pair of sliders 26. In FIG. 2, a part of the ball screw 22 is not shown.

As shown in FIG. 1, the ball screw 22 includes a nut 28 and a screw axis member 30. The nut 28 is attached to, for example, a lower portion 18a of the table 18. The screw axis member 30 is screwed into the nut 28. The axial direction of the screw axis member 30 coincides with the X direction. A drive source (not shown) for rotating the screw axis member 30 is connected to the screw axis member 30. The drive source is, for example, a motor.

As shown in FIG. 1, the pair of sliders 26 support the table 18 from below. The pair of guide rails 24 slidably support the pair of sliders 26. As shown in FIG. 2, the guide rails 24 extend in the X direction. Therefore, the sliders 26 are guided by the guide rails 24 and can slide in the X direction.

The table unit 16 can move in the X direction together with the pair of sliders 26 in accordance with the rotation of the screw axis member 30.

The table 18 is a pedestal that supports a workpiece (not shown) to be machined by the machine tool 10. The table 18 may be provided with a jig (not shown) for fixing the workpiece to the table 18. The machine tool 10 can machine a workpiece supported by the table 18 using a tool mounted on a spindle head (not shown).

The table 18 has end portions 32 (321, 322) in the X direction. The end portions 32 of the table 18 include a first end portion 321 in the X1 direction and a second end portion 322 in the X2 direction. As shown in FIG. 2, telescopic covers 34 (341, 342) are connected to the two end portions 32 of the table 18, respectively. More specifically, a first telescopic cover 341 is connected to the first end portion 321. The first telescopic cover 341 extends in the X1 direction from the first end portion 321. A second telescopic cover 342 is connected to the second end portion 322. The second telescopic cover 342 extends in the X2 direction from the second end portion 322. The telescopic covers 34 are disposed so as to cover the pair of guide rails 24. The telescopic covers 34 extend and contract in accordance with the movement of the table 18 in the X direction.

The table 18 has side portions 36 (361, 362) in the Y direction. The side portions 36 of the table 18 includes a first side portion 361 in the Y1 direction and a second side portion 362 in the Y2 direction. The telescopic covers 34 described above cannot cover the sliders 26 located under the table 18 and a part of the guide rails 24. In view of this, the pair of cover members 20 are attached to the side portions 36 of the table 18 in order to inhibit foreign materials such as chips and cutting fluid from moving around lower parts of the side portions 36 of the table 18 and adhering to the feed axis mechanism 14. More specifically, a first cover member 201 is attached to the first side portion 361. A second cover member 202 is attached to the second side portion 362.

As shown in FIG. 1, the first cover member 201 and the second cover member 202 are line symmetrical with respect to a center line LA of the table 18 which serves as an axis of symmetry and is parallel to the Z direction. Based on this feature, in the following, in order to avoid redundant description, description will be made focusing on one (the second cover member 202) of the pair of cover members 20.

The cover member 20 is a structure (a cover unit) for protecting the feed axis mechanism 14 from foreign materials. More specifically, the cover member 20 is a cover unit for protecting at least a portion of the feed axis mechanism 14 located under the table 18 from foreign materials such as chips and cutting fluid.

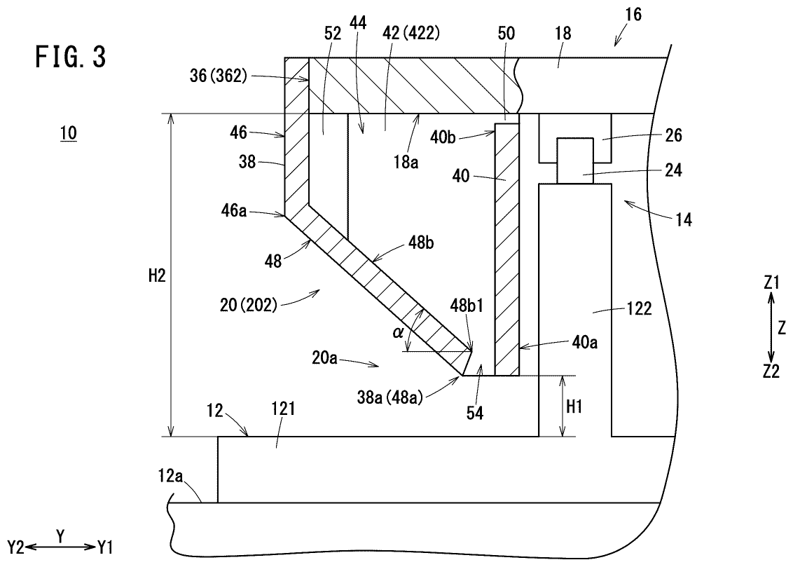

FIG. 3 is a schematic diagram illustrating a part of the machine tool 10. The interior of the cover member 20 is shown in FIG. 3.

The cover member 20 includes an outer wall portion 38, an inner wall portion 40, and a pair of connection wall portions 42. The inner wall portion 40 and the outer wall portion 38 are arranged with a gap therebetween in the Y direction (the horizontal direction). In FIG. 3, the direction from the outer wall portion 38 toward the inner wall portion 40 (the feed axis mechanism 14) coincides with the Y1 direction. The pair of connection wall portions 42 include a first connection wall portion 421 (FIG. 1) provided at an end portion of the cover member 20 in the X1 direction, and a second connection wall portion 422 (FIG. 3) provided at an end portion of the cover member 20 in the X2 direction. The cover member 20 has an internal space 44. The internal space 44 is a space surrounded by the outer wall portion 38, the inner wall portion 40, and the pair of connection wall portions 42.

The outer wall portion 38 is a wall portion that covers the feed axis mechanism 14. The outer wall portion 38 has a first vertical portion (a vertical portion) 46 and an inclined portion 48. The first vertical portion 46 and the inclined portion 48 are preferably connected to each other. For example, the first vertical portion 46 and the inclined portion 48 are preferably integrally formed by welding in the manufacturing stage of the outer wall portion 38.

The first vertical portion 46 is a portion of the outer wall portion 38 extending along the Z direction (the vertical direction). The first vertical portion 46 is attached to the table 18. The first vertical portion 46 may be detachably attached to the table 18.

The inclined portion 48 is a portion of the outer wall portion 38 extending from a lower end portion 46a of the first vertical portion 46. The inclined portion 48 has an inclined surface 48b inclined obliquely downward toward a lower end portion 40a of the inner wall portion 40. The inclined surface 48b is a surface facing the internal space 44. An inclination angle α of the inclined surface 48b with respect to the horizontal plane (a plane parallel to the horizontal plane) is, for example, 45 degrees, but is not limited thereto. The inclination angle α may be appropriately determined within a range of, for example, 10 degrees to 80 degrees.

The inner wall portion 40 is a vertical wall portion located between the outer wall portion 38 and the feed axis mechanism 14. That is, the inner wall portion 40 extends in the Z direction between the outer wall portion 38 and the feed axis mechanism 14. The inner wall portion 40 covers the feed axis mechanism 14 between the outer wall portion 38 and the feed axis mechanism 14. The inner wall portion 40 and the rail support portion 122 of the support member 12 face each other in the Y direction. The inner wall portion 40 and the rail support portion 122 are separated from each other in the Y direction, but are preferably as close as possible to each other. The lower end portion 40a of the inner wall portion 40 faces a relatively lower portion of the rail support portion 122 of the support member 12 in the Y direction. The lower end portion 40a of the inner wall portion 40 is preferably located below a lower end portion 48a of the inclined portion 48. More strictly, the lower end portion 40a of the inner wall portion 40 is preferably located below a lower end 48b1 of the inclined surface 48b. The lower end portion 48a of the inclined portion 48 also serves as a lower end portion 38a of the outer wall portion 38. An upper end portion 40b of the inner wall portion 40 is disposed at a position facing the guide rail 24 or the slider 26 in the Y direction. In other words, the upper end portion 40b of the inner wall portion 40 is positioned above the rail support portion 122 of the support member 12 in the Z direction. It is preferable for a space between the upper end portion 40b of the inner wall portion 40 and the lower portion 18a of the table 18 to be closed, but the present disclosure is not limited thereto. For example, a relatively small clearance 50 as shown in FIG. 3 may be formed between the upper end portion 40b of the inner wall portion 40 and the lower portion 18a of the table 18 due to manufacturing errors of the table 18 and the inner wall portion 40. Such a clearance 50 is allowed.

The pair of connection wall portions 42 are wall portions that connect the outer wall portion 38 and the inner wall portion 40. As described above, the pair of connection wall portions 42 includes the first connection wall portion 421 (see also FIG. 1) and the second connection wall portion 422 (FIG. 3). It is preferable for the space between the upper end portion of the connection wall portion 42 and the lower portion 18a of the table 18 to be closed, but the present disclosure is not limited thereto. As with the space between the upper end portion 40b of the inner wall portion 40 and the lower portion 18a of the table 18, a relatively small clearance is allowed to be formed between the upper end portion of each of the connection wall portions 42 and the lower portion 18a of the table 18.

The outer wall portion 38 and the connection wall portions 42 are connected to each other. For example, the outer wall portion 38 and the connection wall portions 42 are integrally formed by being welded in a manufacturing stage of the cover member 20. The inner wall portion 40 and the connection wall portions 42 are connected to each other. For example, the inner wall portion 40 and the connection wall portions 42 are integrally formed by being welded in a manufacturing stage of the cover member 20. Thus, the cover member 20 is configured as a cover unit integrally including the outer wall portion 38 and the inner wall portion 40.

The cover member 20 further includes an insertion portion 52 and a gap 54.

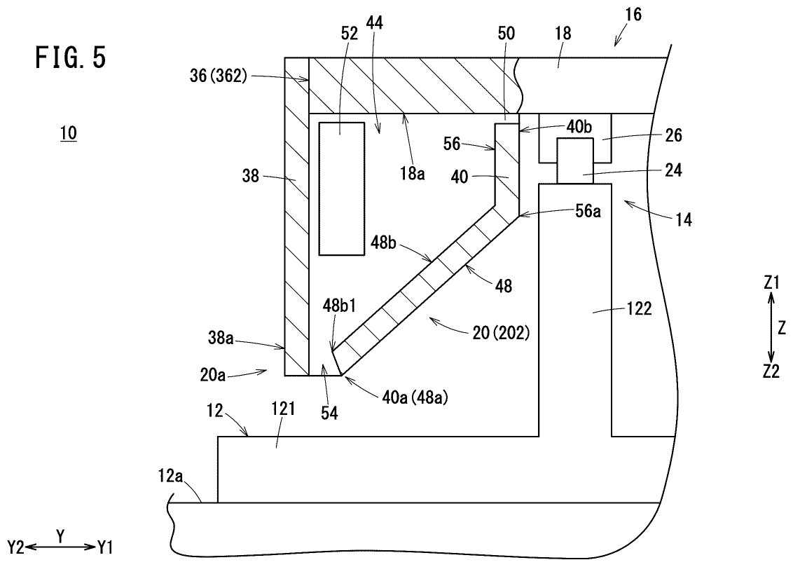

The insertion portion 52 is a cutout portion that allows a member (an insertion member) to be inserted into the cover member 20 in the X direction. A specific insertion member is not limited, but is, for example, a tubular member such as a hose that supplies lubrication oil to the slider 26. The shape of the insertion portion 52 is not limited to the shape shown in FIGS. 1 and 3. The insertion portion 52 may be an opening formed in the cover member 20 (also see FIG. 5).

The gap 54 is located between the lower end portion 48a of the inclined portion 48 and the lower end portion 40a of the inner wall portion 40. In other words, the gap 54 is located at a lower end portion 20a of the of the cover member 20. The gap 54 opens downward in the lower end portion 20a of the cover member 20. The lower end portion 20a of the cover member 20 and the base portion 121 of the support member 12 are separated from each other in the Z direction. Therefore, the internal space 44 of the cover member 20 surrounded by the outer wall portion 38, the inner wall portion 40, and the connection wall portions 42 communicates with the external space of the cover member 20 via the gap 54. As described above, the inclined portion 48 is inclined obliquely downward toward the lower end portion 40a of the inner wall portion 40, and thus the size of the gap 54 in the Y direction is set to be relatively narrow. A first distance H1 and a second distance H2 are also shown in FIG. 3. The first distance H1 is a separation distance in the Z direction between the lower end of the gap 54 (the lower end portion 20a) and the upper surface of the base portion 121 of the support member 12. The second distance H2 is a separation distance in the Z direction between the lower surface of the lower portion 18a of the table 18 and the upper surface of the base portion 121 of the support member 12. The first distance H1 is shorter than the second distance H2 (H1<H2). The first distance H1 is, for example, one fifth or less of the second distance H2, but is not limited thereto this feature. The first distance H1 may be, for example, one tenth or less of the second distance H2. The first length H1 is set as short as possible, but is preferably longer than the size of the gap 54 in the Y direction.

As described above, the cover member 20 can be detachably attached to the table 18. In this case, a plurality of cover members 20 having different sizes of the gap 54 in the X direction or the Y direction may be selectively attached to the table 18.

The embodiment has been described above. According to the embodiment, the cover member 20 has the advantageous effects described below.

The outer wall portion 38 inhibits foreign materials such as chips and cutting fluid from reaching the feed axis mechanism 14. The inner wall portion 40 inhibits the foreign materials that have moved around the outer wall portion 38, from reaching the feed axis mechanism 14. For example, the inner wall portion 40 inhibits the foreign materials that has entered the internal space 44 via the insertion portion 52 described above, from reaching the feed axis mechanism 14. In this way, since the cover member 20 includes the wall portions (the outer wall portion 38 and the inner wall portion 40) of the plurality of layers, the foreign materials are favorably inhibited from reaching the feed axis mechanism 14. The lower end portion 38a of the outer wall portion 38 and the lower end portion 40a of the inner wall portion 40 form the gap 54. The gap 54 can discharge the foreign materials that have entered the internal space 44 to the lower side of the cover member 20. Moreover, according to the present embodiment, the outer wall portion 38 has the inclined portion 48 that is inclined obliquely downward toward the lower end portion 40a of the inner wall portion 40.

The inclined portion 48 can cause the foreign materials that have entered the internal space 44 to slide down toward the gap 54 along the inclined surface 48b of the inclined portion 48. Further, the inclined portion 48 is inclined obliquely downward toward the lower end portion 40a of the inner wall portion 40, whereby the relatively narrow gap 54 is formed. Accordingly, it is possible to inhibit the foreign materials from entering the internal space 44 through the gap 54.

The cover member 20 is a cover unit integrally including the outer wall portion 38 and the inner wall portion 40. Therefore, when the table 18 moves in the feed axis direction, the outer wall portion 38 and the inner wall portion 40 move integrally in the feed axis direction. Accordingly, it is possible to continuously maintain a state in which an area under the table 18 is covered with the outer wall portion 38 and the inner wall portion 40. As described above, in the present embodiment, the X direction coincides with the axial feed direction of the table 18.

The outer wall portion 38 and the inner wall portion 40 are connected to each other via the connection wall portion 42. Accordingly, a gap more than necessary is not formed in the cover member 20. Therefore, the foreign materials are inhibited from entering the internal space 44 of the cover member 20. Each of the outer wall portion 38 and the inner wall portion 40 may be connected to the connection wall portion 42, for example, by welding.

The inner wall portion 40 is a vertical wall portion. The vertical wall portion is likely to repel foreign materials. The inner wall portion 40 is a vertical wall portion, and thus can more reliably repel the foreign materials that have entered the internal space 44. In this case, the foreign materials are repelled toward the inclined surface 48b. Therefore, the effect of guiding the foreign materials to the gap 54 by the inclined surface 48b can be more favorably exhibited.

The lower end portion 40a of the inner wall portion 40 is located below the lower end portion 48a of the inclined portion 48. Accordingly, it is possible to cause the foreign materials sliding down along the inclined surface 48b to collide with the inner wall portion 40. The foreign materials that have collided with the inner wall portion 40 are discharged from the gap 54 while being repelled in a direction toward the outer wall portion 38 from the inner wall portion 40. That is, the inner wall portion 40 can discharge the foreign materials from the gap 54 while repelling the foreign materials in the direction opposite to the direction toward the feed axis direction. Accordingly, it is possible to more favorably inhibit the foreign materials from reaching the feed axis mechanism 14.

The first distance H1 described above is set as short as possible, but is preferably longer than the size of the gap 54 in the Y direction. When the first distance H1 is longer than the size of the gap 54 in the Y direction, any concern that the foreign materials discharged from the gap 54 clog the gap 54 can be reduced.

A plurality of cover members 20 having different sizes may be selectively attached to the table 18. Accordingly, the size of the gap 54 can be changed according to, for example, the model or model number of the machine tool 10, the content of the machining to be executed, and the like. By changing the size of the gap 54, for example, the maximum value of the amount of the foreign materials discharged through the gap 54 per unit time can be changed. The method of attaching the cover member 20 to the table 18 is, for example, screwing, but is not particularly limited to the method.

The cover member 20 includes the insertion portion 52 through which an insertion member can be inserted in the X direction (the feed axis direction). Thus, even when the table 18 moves in the feed axis direction, the cover member 20 and the insertion member do not interfere with each other. Therefore, the cover member 20 does not hinder the table 18 from moving in the feed axis direction.

The embodiment may be modified as follows. In the following modifications, descriptions that overlap or are duplicative of those stated in the embodiment will be omitted. In the drawings used in the following modifications, the same reference numerals are used for the same components as those described in the embodiment.

### (Modification 1)

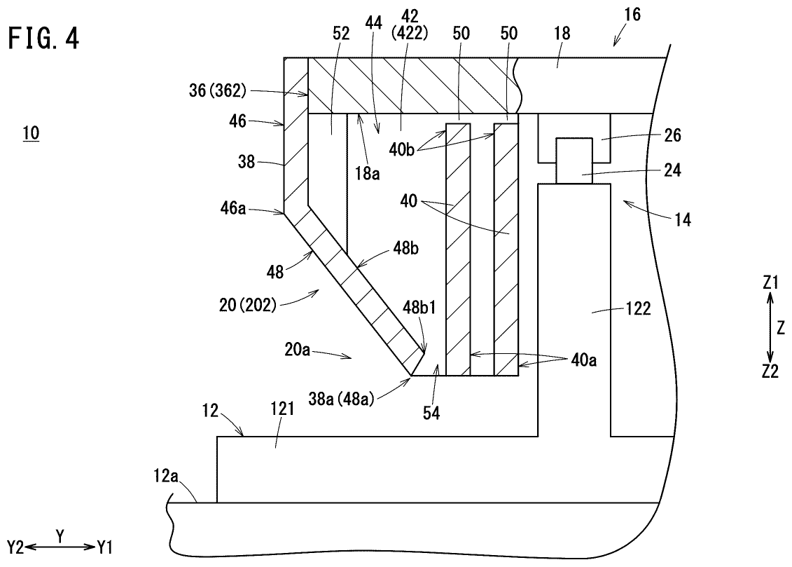

FIG. 4 is a schematic diagram illustrating a machine tool 10 according to Modification 1.

The cover member 20 may include a plurality of inner wall portions 40. In this case, the plurality of inner wall portions 40 may be arranged along the Y1 direction (the first direction) from the outer wall portion 38 toward the feed axis mechanism 14. By providing the plurality of inner wall portions 40 that prevent the foreign materials from reaching the feed axis mechanism 14, the foreign materials are further inhibited from reaching the feed axis mechanism 14.

### (Modification 2)

FIG. 5 is a schematic diagram illustrating a machine tool 10 according to Modification 2.

The inner wall portion 40 may have an inclined portion 48. More specifically, the inner wall portion 40 may include a vertical portion (a second vertical portion) 56 and the inclined portion 48.

The second vertical portion 56 is a wall portion that includes an upper end portion 40b of the inner wall portion 40 and extends in the up-down direction. The inclined portion 48 of the inner wall portion 40 extends obliquely downward from a lower end portion 56a of the second vertical portion 56 toward a lower end portion 38a of the outer wall portion 38.

In this case, the inclined portion 48 also has an inclined surface 48b directed toward the internal space 44. The inclined portion 48 can cause the foreign materials to slide down toward the gap 54 along the inclined surface 48b.

The outer wall portion 38 shown in FIG. 5 is a vertical wall portion, but is not limited to this feature. That is, although not shown, each of the outer wall portion 38 and the inner wall portion 40 may have the inclined portion 48.

### (Modification 3)

The shape of the first cover member 201 attached to the first side portion 361 of the table 18 and the shape of the second cover member 202 attached to the second side portion 362 of the table 18 may be non-line symmetric.

For example, the size of the gap 54 of the first cover member 201 in the X direction or the Y direction may be different from the size of the gap 54 of the second cover member 202 in the X direction or the Y direction.

### (Modification 4)

The machine tool 10 may further include a telescopic cover (not shown) connected to the support member 12 (the slide portion 12a). The telescopic cover covers the above-described guide member (not shown) that supports the slide portion 12a. The telescopic cover extends and contracts in accordance with the movement of the support member 12 in the Y direction. By providing such a telescopic cover in the machine tool 10, the guide member, the slide portion 12a, and the like can be protected from foreign materials such as chips and cutting fluid.

### (Combination of Plural Modifications)

The above-described plurality of exemplary modifications may be combined as appropriate within a range in which there are no contradictions therebetween.

According to the above embodiment, the cover member 20 can reduce the amount of foreign materials reaching the feed axis mechanism 14.

With respect to the above embodiment, the following supplementary notes are further disclosed.

### (Supplementary Note 1)

The cover member (20) according to the present disclosure protects the feed axis mechanism (14). The feed axis mechanism feeds the table (18) of the machine tool (10) while supporting the table from below. The cover member includes the outer wall portion (38) that covers the feed axis mechanism, the inner wall portion (40) that is located between the outer wall portion and the feed axis mechanism, is separated from the outer wall portion, and covers the feed axis mechanism, wherein one of the outer wall portion or the inner wall portion includes the inclined portion (48) extending obliquely downward toward the lower end portion (38a, 40a) of another of the outer wall portion or the inner wall portion, and forming the gap (54) between the inclined portion and the lower end portion.

### (Supplementary Note 2)

In the cover member according to Supplementary Note 1, the cover member may be the cover unit that integrally includes the outer wall portion and the inner wall portion.

### (Supplementary Note 3)

In the cover member according to Supplementary Note 1 or 2, the plurality of the inner wall portions may be arranged in the first direction from the outer wall portion toward the feed axis mechanism.

### (Supplementary Note 4)

In the cover member according to any one of Supplementary Notes 1 to 3, the outer wall portion may include the vertical portion extending in the up-down direction and the inclined portion connected to the lower end portion of the vertical portion, and the inner wall portion may be the vertical wall portion extending in the up-down direction.

### (Supplementary Note 5)

In the cover member according to Supplementary Note 4, the lower end portion (40a) of the inner wall portion may be located below the lower end portion (48a) of the inclined portion.

### (Supplementary Note 6)

The machine tool (10) according to the present disclosure includes the cover member according to any one of Supplementary Notes 1 to 5, the table, and the feed axis mechanism.

### (Supplementary Note 7)

In the machine tool according to Supplementary Note 6, the plurality of the cover members each having the gap of the different size may be selectively attachable to the table.

Although the present disclosure has been described in detail, the present disclosure is not limited to each of the embodiments described above. Within a range that does not depart from the essence and gist of the present disclosure, or within a range that does not depart from the purpose of the present disclosure derived from the content described in the claims and their equivalents, various additions, substitutions, changes, partial deletions, or the like can be made to such embodiments. These embodiments may also be implemented in combination. For example, in the embodiments described above, the order of the operations and the order of the processes are shown as examples, and the present invention is not limited to such operations and processes. Further, The same applies to the case where numerical values or mathematical expressions (equations) are used in the description of the above-described embodiments.

### REFERENCE SIGNS LIST

10: machine tool
14: feed axis mechanism
18: table
20: cover member
38: outer wall portion
38a: lower end portion
40: inner wall portion
40a: lower end portion
42: connection wall portion
44: internal space
46: first vertical portion
48: inclined portion
48a: lower end portion
54: gap

1. A cover member that protects a feed axis mechanism, the feed axis mechanism feeding a table of a machine tool while supporting the table from below, the cover member comprising:
an outer wall portion that covers the feed axis mechanism;
an inner wall portion that is located between the outer wall portion and the feed axis mechanism, is separated from the outer wall portion, and covers the feed axis mechanism;
wherein one of the outer wall portion or the inner wall portion includes an inclined portion extending obliquely downward toward a lower end portion of another of the outer wall portion or the inner wall portion, and forming a gap between the inclined portion and the lower end portion.

2. The cover member according to claim 1, wherein the cover member is a cover unit that integrally includes the outer wall portion and the inner wall portion.

3. The cover member according to claim 1, wherein a plurality of the inner wall portions are arranged in a first direction from the outer wall portion toward the feed axis mechanism.

4. The cover member according to claim 1, wherein the outer wall portion includes a vertical portion extending in an up-down direction and the inclined portion connected to a lower end portion of the vertical portion, and
the inner wall portion is a vertical wall portion extending in the up-down direction.

5. The cover member according to claim 4, wherein the lower end portion of the inner wall portion is located below a lower end portion of the inclined portion.

6. A machine tool comprising:
the cover member according to claim 1;
the table; and
the feed axis mechanism.

7. The machine tool according to claim 6, wherein a plurality of the cover members each having the gap of a different size are selectively attachable to the table.
